(19) United States
(12) Patent Application Publication
(10) Pub. No.: US 2008/0308630 A1
(43) Pub. Date: Dec. 18, 2008

(54) USER-REQUIREMENT DRIVEN SHOPPING ASSISTANT

(75) Inventors: Kulvir Singh Bhogal, Forth Worth, TX (US); Angela Richards Jones, Durham, NC (US); Robert Ross Peterson, Austin, NC (US); Lisa Anne Seacat, San Francisco, CA (US)

Correspondence Address: IBM CORPORATION, 3039 CORNWALLIS RD., DEPT. T81 / B503, PO BOX 12195, RESEARCH TRIANGLE PARK, NC, 27709, US

(73) Assignee: INTERNATIONAL BUSINESS MACHINES CORPORATION, Armonk, NY (US)

(21) Appl. No.: 11/764,312

(22) Filed: Jun. 18, 2007

(51) Int. Cl. G06F 17/00

(52) U.S. Cl. 235/383

(57) ABSTRACT

Device, method and system for providing shopping assistance information to customers using RFID tagged items in a store equipped with on-board or hand-held shopping cart RFID readers and display devices modified to have a personal product specification criteria data input interface.

### FIELD OF THE INVENTION

This invention relates generally to shopping assistance systems and, more particularly, it relates to a device, method and system for providing shopping assistance information to customers in an RFID (Radio Frequency Identification) product tagged environment in which the items in a store are tagged with RFID tags and in which the store is equipped with a central computer system and product data database linked to the shopping assistance device to display useful information to the customer using the system.

### BACKGROUND

Many shopping assistance devices and systems are known in the art. Some, as in U.S. Pat. No. 5,918,211 utilize the now-ubiquitous UPC bar codes by providing a scanner in the user's shopping cart to read and display useful information regarding the products the customer puts into the cart and to assist in checkout of the contents at the checkout and payment counter.

Other systems of more technologically advanced nature utilize the now commonplace RFID tag systems in a similar fashion such as that shown in Published Patent Application US 2002/0170961 A1 in which an in-cart shopping assistance device reads the RFID tags associated with the various items a user may put into or remove from the cart. This system displays information retrieved from the store's central database over a wireless link to inform the user about other related purchases that might be considered, sales prices or other information of interest to the customer regarding the items in his or her shopping cart and displays this information either on a display device associated with the in-cart assistance device or on a hand-held device of the customer's own such as a PDA, Cellular Telephone, a pager or the like for assisting the customer in managing his or her selections in the store.

Another advanced system is already in use in Germany and some other countries in which RFID tagged items in a store are read by an onboard RFID reader and display device that can guide the shopper through the store with illustrative maps of product locations, prices, sales information, etc. and which also assists in automatically providing checkout or charge totals for the shopper's cart contents. This system can be seen in some detail online at http://www.future-store.org/ in which shoppers can be guided electronically to find desired products that are tagged with RFID chips and whose locations are tracked by RFID readers in the store, e.g. on “smart” shelves or other reader systems. Smart shopping carts are equipped RFID tags and a reader can verify the purchase of items as they are placed in the cart and, if desired, can communicate wirelessly with a billing system to automatically bill the customer for purchases.

Still another prior art RFID tag customer assistance system is shown in the US Patent Application 20060163350 in which an RFID enabled cart has an RFID reader to determine what is in the cart, whether the customer has paid for the items in the cart, and to enable the store proprietors to determine and manage their inventory, billing, etc.

However, in none of the known systems of the general sort described above is there any provision for assisting the shopper to learn personally-customized item specification particulars or to have the system apply personal selection parameters to prospective product purchases. This can become a significant problem when, for example, a particular shopper may have special dietary needs and must carefully screen his or her purchases in a grocery store, for example, to determine whether a prospective purchase item may have too much sodium, or too many calories, or too much sugar, or too high fat content, etc. which are important to that specific shopper for his or her own personal reasons. The examples just given are by no means exhaustive; for example, a particular shopper may have food allergies (peanuts, wheat gluten, seafood, lactose, dairy fat, preservatives or the like) or may have specific preferences for equivalent product brands with lower prices or special sale prices, discount coupon correspondence, etc.

### SUMMARY

The present invention provides a device, method and system for providing shopping assistance information to customers using RFID tagged items in a store equipped with on-board or hand-held shopping cart RFID readers and display devices modified to have a personal product specification criteria data input interface in accordance with this invention.

Particularly, the present invention modifies the usual hand-held or onboard shopping cart attachment device that communicates with the store's central computer and product database to retrieve information stored therein regarding a chosen item such as manufacturer's name, suggested price, product contents and ingredients to assist the shopper in making choices that are in conformance to his or her specific product requirement parameters that are entered by the shopper into the onboard shopping cart RFID reader via a data entry interface as provided in this invention. All of the usual functions of the on-board shopping assistance device are retained, but the improved shopping assistance device and system and method of use thereof enable the user to carefully screen potential purchases for adherence to that particular user's own special criteria or profile and it enables alerting the user when any prospective purchase product does not meet the entered criteria.

### BRIEF DESCRIPTION OF THE DRAWINGS

The foregoing and other objects and advantages of the invention will be appreciated more fully from the following further description thereof with reference to the accompanying drawings, wherein:

FIG. 1 illustrates schematically the general structure of a typical in-store RFID customer assistance system that operates wirelessly to scan items in the store using RFID scanning and reading devices and which communicates with the store's central computer and database to retrieve and make available to the customer using the system the data found to be associated with each prospective purchase item scanned by the on-board RFID reader device. Alternatively, the shopper might be provided a hand-held RFID scanning and reading device linked to the store's central computer and database.

FIG. 2 is a block diagram in greater detail of the system generally illustrated in FIG. 1 and which includes the shopper's personal selection criteria data profile entry device and the profile data input interface to the on-board RFID reader system in the usual shopping cart attachment device.

FIG. 3 is a schematic programming flow and steps in the method of use of the RFID customer assistance system of the invention.

### DETAILED DESCRIPTION

The invention will now be described in detail with reference to a preferred embodiment thereof as illustrated in the Drawings mentioned above.

The present invention assumes that each of the items or products sold in a store or shopping area includes a conventional Radio Frequency Identification (RFID) tag attached to the merchandise to facilitate tracking the movement of merchandise without any direct contact with the items being monitored. The nature and structure of such tags is well known and need not be described further herein, but the typical RFID tag on a product includes an antenna and a silicon chip containing modulation circuitry, control logic and non-volatile memory. The chip derives its electrical power from radio signals received by the antenna or from a battery, and is able to exchange data wirelessly with a RFID tag reader by demodulating and modulating the radio signals. A computer coupled to the RFID tag reader can read and write to and from the memory of the RFID tag using the radio signal transmissions. Item information such as name of the item, manufacturer, price, etc. is normally stored in the RFID tag of the product using either a retail identifier code such as the SKU number or UPC (Universal Product Code) that represents in the store's database the name, manufacturer, price, sales price, and any other data about the product which the store wishes to have associated with each particular tagged product such as the product's ingredients, expiration data, manufacturer's production code, etc.

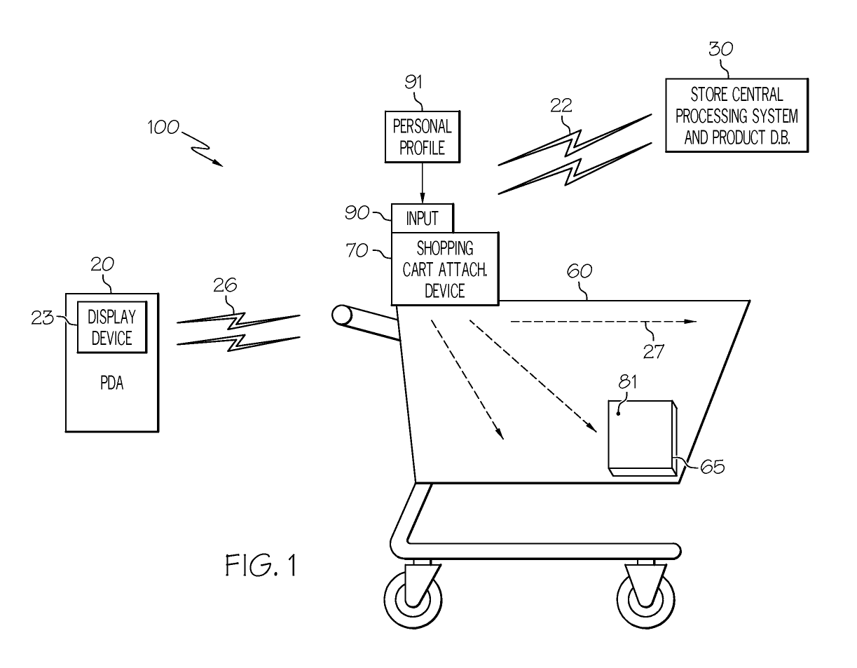

Turning to FIG. 1, a schematic representation of a system 100 for providing customer shopping assistance in accordance with this invention is shown. The system 100 is implemented as known in the prior art for a store, a shopping mall or any other shopping area or environment. It includes a shopping cart attachment device 70 which may be hand-held or, as shown, installed on a shopping cart 60 or any other shopping vehicle or container used by the shopper, a personal digital assistance (PDA) device 20 which includes a display device 23 which is carried by the user, and a central processing system 30 for communicating with the shopping cart attachment device, all of which are operatively coupled together wirelessly as shown schematically in the Figure.

The shopping cart attachment device 70 is configured to detect automatically RFID-tagged items such as item 65 having an RFID tag 81 as they are placed into or removed from the shopping cart 60. The attachment device 70 also reads automatically the RFID tags on these items by radio link 27 and thereby obtains the item information on the items placed into or removed from the cart 60. Alternatively, if the RFID scanner and reader is hand-held, it may be used to scan items on shelves to alert the customer when he or she is adjacent to some desired item or an item which meets the shopper's personal selection criteria entered by the user.

In addition, the shopping cart attachment device 70 of the present invention is also provided with a data input interface 90 which enables the attachment device 70 to accept input of data from a user's personal profile data input device, 91. In the context of the preferred embodiment, the data input interface may be a magnetic media reader which may be a magnetic stripe reader which reads the data encoded magnetically on a user's store loyalty card 91 which has been enhanced by the user to include any personal product selection criteria that reflect the user's preference and/or sensitivity to certain aspects of the potential products that a purchaser might select. For example, the magnetic stripe may be encoded by the user at a terminal provided by the store for entry of personal data onto the user's store loyalty card so that the information is not made directly available to the store itself and so that the user's privacy over this information is maintained. The user may, for example, wish to enter product selection criteria of “sodium less than X mg” or screen for terms in the product's list of ingredients such as “contains peanuts”, “lactose”, “preservatives”, “wheat gluten”, “dairy fat”, “palm oil” or any of an endless variety of dietary sensitivity criteria which the user may have or desire to have screened and identified to the purchaser. Similarly, the user may wish to screen for particular product names, sale or special prices, conformance to discount coupons the user may have, etc.

The personal data input device 90 may also be the user's PDA 20 (Personal Digital Assistant) which has been loaded by the user with his or her product selection criteria data and which can be downloaded to the shopping cart attachment device's input interface device 90 which, in this example, would ordinarily be a communications interface 71 linked wirelessly via link 26 to the user's PDA device 20. Or the personal input device 90 might be one of the ubiquitous portable memory devices in widespread use such as a USB (Universal Synchronous Bus) memory stick, magnetic disc or flash card memory device which have been configured by the user on a home computer or via the user's PDA 20 to contain the desired product selection or screening criteria for the user. Similarly, a user's SIM (Subscriber Identity Module (SIM) is a removable smart cart for mobile wireless communications devices or telephones) card of his or her personal portable cellular telephone could also be configured with this information and, in each of these alternative examples, the shopping cart attachment device 70 would have to be provided with the matching data input interface 90 for the USB memory device or the like.

In addition, the shopping cart attachment device 70 is enabled to perform wireless communications over link 22 with the store's central computer or processing system 30 and to perform wireless communications over link 26 with a user's PDA 20 in accordance with well-known communications techniques such as infrared, Bluetooth® (Trademark of Bluetooth SIG) radio wireless techniques, or other similar techniques in combination with the usual computer systems LAN (Local Area Network) network technologies or other internal communications techniques. Bluetooth communications are preferred in the embodiment herein because a variety of small, portable and inexpensive radio unit devices such as PDA's, mobile telephones, personal computers may be configured to incorporate the Bluetooth structures and protocols to assure easy radio linking of the devices to the shopping cart attachment device 70. All necessary information regarding the Bluetooth standard and technology is publicly available at the website http:www.bluetooth.com.

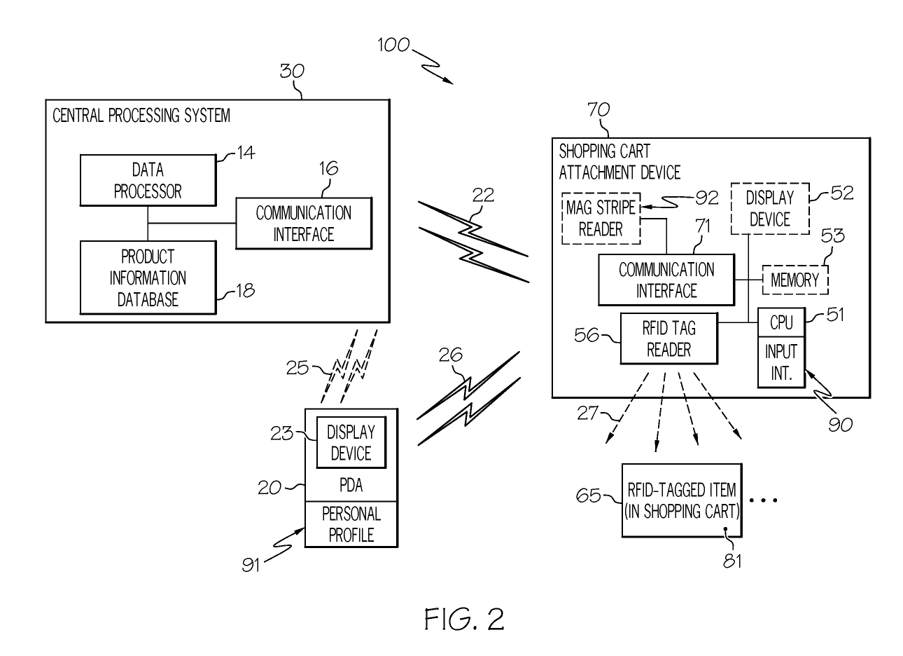

In FIG. 2, a block diagram of the system 100 is illustrated to show in greater detail a preferred embodiment of the invention. The usual RFID system has been modified as shown in FIG. 2 to include a personal shopping parameter data file 91 for input into the data input interface 90 of the CPU 51 in the shopping cart attachment device 70. As has been previously explained, the personal parameter data file may be encoded onto a magnetic stripe on the customer's loyalty card for the store, or it may be loaded by the customer into his or her PDA 20 for downloading via the wireless link 26 into the communications interface 71 of the shopping cart attachment device, where the communications interface 71 is controlled by the CPU 51 which enables interface 71 to load received data through the input interface 90 to the CPU 51. There are numerous equivalent means of providing a data input interface to the CPU 51 as previously described above, including use of a magnetic media reader or, in the alternative, a USB input to which a typical portable memory device such as a memory stick or flash card loaded with the personal shopping parameters that define the criteria the shopper wishes to impose on any selections he or she may make in the store. These criteria can be downloaded directly into the CPU 51 and its memory 53 using this technology as is well-known in the art.

The communication interface 71 of the cart attachment device 70 carries out the control of wireless communications links 22 and 26 to communicate with the store's central data processing system 30, via it's communications interface 16, to access the product database 18 to retrieve any information therein related to any given scanned item 81 whose data has been read from the RFID tagged item 81 by the RFID tag reader 56 in the shopping cart attachment device 70. The communications interface 71 of the shopping cart attachment device also conducts the communications over the wireless link 26 with the PDA 20 or with a magnetic stripe reader 92, as is an option of this invention, to query the contents of the personal criteria data file in the PDA 20 or the magnetically encoded stripe of a user's store loyalty card as read by magnetic stripe reader 92. Alternatively, as already described, direct data input through interface 90 may be achieved by use of the usual USB data procedure as is well known in the art.

Wireless communications over links 22 and 26 may be easily achieved using the short-range wireless communications protocols of the Bluetooth standards described above, and are implemented using at least one Bluetooth radio unit known in the art and which includes both the hardware such as an antenna and transmitter and the software for implementing the short-range radio communications of the Bluetooth standard.

The RFID tag reader 56 of the shopping cart attachment device 70 is the usual RFID reader structure known in the art. The tag reader 56 automatically detects all RFID-tagged items 65 placed in or removed from the shopping cart 60 and automatically scans the RFID tags 81 on such items.

When a customer places RFID-tagged items 65 into his or her shopping cart 60 during the shopping process, the tag reader 56 reads the item information stored in the RFID tag 81 of each item, passes the information from the tag to the CPU 51 and the CPU 51 queries the stores' database 18 via the communications interface 71 and the wireless link 22 to retrieve the information stored in the database. The CPU 51, upon receipt of the information from the database 18, examines the content thereof in comparison to the customer's already-inputted personal product selection criteria and alerts the customer of the result of this comparison via an optional display device 52 in the shopping cart attachment device 70, or over the wireless link 26 to the customer's PDA 20 where it may be displayed on the display 23 of the PDA 20. This enables the customer to know that, for example, his or her prospective purchase item 65 either meets his criteria or does not meet his criteria. Thus, the customer is easily enabled to screen out unwanted levels of, say, sodium or to avoid products containing peanuts or any other ingredient which the customer has stored in his or her personal profile of product selection criteria. Of course, the personal selection criteria may include non-medical or dietary criteria such as price, size, color, etc. so that the customer will be alerted at once should he choose a wrong-sized article of clothing in a clothing store, for example.

As is well-known in the RFID systems of prior art, any information scanned by the RFID tag reader 56 is continually transmitted to the CPU 51 of the shopping cart attachment device 70 which in turn communicates it over link 22 using communication interface 71 to the communication interface 16 of the store's central processing system 30 where the data processor 14 interprets the information, accesses the product information database 18, and returns the information therein which is associated with the particular scanned tag back over the wireless link 22 to the shopping cart attachment device 70. As is well-known and in use already, the store's processing system 30 may also provide the customer with other related information of possible usefulness to him or her such as suggested additional purchase items related to the selected and scanned item, their location in the store including a brief route map to assist the customer in locating such additional purchase items, or it may identify discount coupons or availability of special pricing, etc. all of which are if immediate possible usefulness to the shopper. All of this information is displayed either via the customer's PDA 20 on it's own display 23 or on the display 52 of the shopping cart attachment device 70 as is well-known in the art.

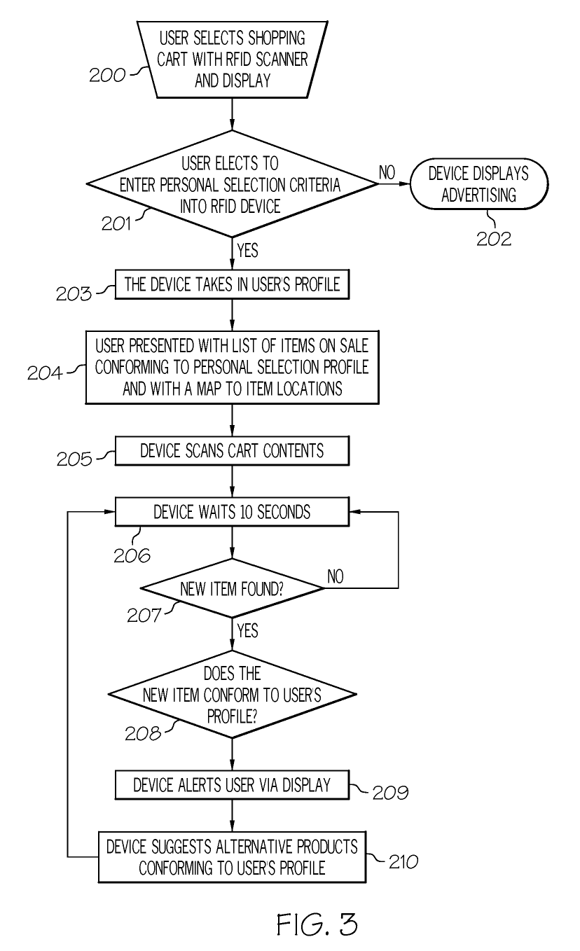

FIG. 3 illustrates the procedural flow of the method of use of the system 100 in accordance with the invention. Typically, the flow of operations will be performed in software running in the CPU 51 of the shopping cart attachment device 70 to guide the shopper through the various interactions he or she may have with the system 100.

As shown in FIG. 3, the process begins as a shopper enters the store, selects a shopping cart 60 outfitted with a shopping cart attachment device 70, as described in block 200 of FIG. 3. Then the user swipes his or her preconfigured store loyalty card through the shopping cart attachment device's magnetic stripe reader 92 or, alternatively, plugs his or her portable USB memory device into the appropriate interface 90 of the shopping cart attachment device 70, or alternatively, accesses his or her preloaded personal selection criteria file in his or her PDA 20 and downloads his or her personal selection criteria into the CPU 51 as already explained above. As shown in block 201, the shopper either does enter his or her personal product selection criteria or does not, in which case the system 100 is programmed to display advertising material, for example, either on the shopping cart attachment device's display 52 or the shopper's PDA display 23.

If the user does enter his or her personal product selection criteria in block 201, then the process continues in block 203 where the magnetic stripe reader 92 or the other means of data entry described, extracts the user's product selection criteria profile data from the magnetic stripe on the card or other memory media as described earlier. Proceeding to block 204, the system presents the shopper with a list of items on sale that conform to their shopping profile and displays an in-store map the will assist the shopper in locating such items in the store. Alternatively, block 204 could be omitted and the shopper would proceed unassisted to pass through the store making potential selections of products and placing them into his or her shopping cart 60.

If the shopper places an item into the shopping cart 60, the shopping cart attachment device 70, via the RFID tag reader 56, will scan the content of any RFID-tag, retrieve from the store's central product database 18 via the methods and devices previously described the information about the tagged product and, optionally, will display this information using the display devices mentioned above. In the preferred embodiment illustrated in FIG. 3, however, the process proceeds to wait for a period of time, for example 10 seconds as shown in block 206 and determines, in block 207, whether a new item has been found in the shopper's cart 60. If a new item has been placed into the cart 60, the system compares the retrieved information about the item to the customer's personal shopping criteria profile to determine whether the item conforms thereto as shown in block 208 and alerts the customer on either the display 52 of the shopping cart attachment device or the user's PDA display 23 as to the results of the comparison. In the example illustrated in block 208, the user's health selection criteria profile is compared to the retrieved product information and the user is alerted as to the results. Then the system may suggest to the shopper either alternative products that would match his or her shopping criteria and direct him to the location in the store for such an item, or it may alert the shopper to variants of the product that would be in conformance with the shopper's expressed criteria.

These processing steps described in FIG. 3 may be implemented by computer programs in conjunction with the existing hardware components of the shopping cart attachment device 70. The techniques and methods for so doing and for embodying such programs onto media for loading into such devices are all well-known in the art of RFID shopping assistance systems and need not be described further herein.

The invention having been described with illustrative embodiments and various optional details will be understood therefore to include a variety of possible selection criteria other than personal medical, dietary, health, size, color, brand or any other possible product characteristic or ingredient, and to be applicable to any type of product sold in any type of store or merchandising environment, and are therefore intended to be included within the scope of the following claims.

What is claimed is:

1. A shopper's assistance device comprising:
a communications interface supporting wireless communications with a store's central processing system,
a tag reader for reading information from an item bearing a data-bearing tag;
a personal shopping criteria data entry interface; and
a processor for controlling the communications interface and the tag reader.

2. The device of claim 1, wherein the tag reader is an RFID tag reader for automatically reading the content of any RFID-tagged items placed in sufficient proximity thereto.

3. The device of claim 1 wherein said personal shopping criteria data entry interface is a magnetic data media reader.

4. The device of claim 2, wherein said personal shopping criteria data entry interface is a magnetic data media reader.

5. The device of claim 1 wherein said personal shopping criteria data entry interface is an USB port to said processor.

6. The device of claim 2 wherein said personal shopping criteria data entry interface is an USB port to said processor.

7. The device of claim 1 wherein said personal shopping criteria data entry interface is a wireless data link from a portable wireless communications device carried by the shopper to the shopping assistance device.

8. The device of claim 2, wherein said personal shopping criteria data entry interface is a wireless data link from a portable wireless communications device carried by the shopper to the shopping assistance device.

9. The device of claim 1, further comprising display means for displaying information obtained by said tag reader to said user.

10. The device of claim 9, wherein said processor compares the information obtained by said tag reader to said personal shopping criteria and displays the result thereof to said user via said display means.

11. A system for providing shopping assistance to a user, comprising a personal shopping assistance device, including:
a communications interface capable of wireless communications with a store's central processing system and to any portable wireless communications equipment carried by a user;
a tag reader for automatically reading item information from any tagged item placed into the user's shopping cart;
a processing unit for controlling said communications interface and said tag reader and communications to a store's central processing system; and
a personal shopping criteria data entry interface.

12. The system of claim 11, wherein said tag reader is an RFID tag reader for automatically reading the content of any RFID-tagged items placed in sufficient proximity thereto.

13. The system of claim 10 wherein said personal shopping criteria data entry interface is a magnetic data media reader.

14. The system of claim 11, wherein said personal shopping criteria data entry interface is a magnetic data media reader.

15. The system of claim 11, wherein said personal shopping criteria data entry interface is an USB port to said processor.

16. The system of claim 12, wherein said personal shopping criteria data entry interface is an USB port to said processor.

17. The system of claim 11, wherein said personal shopping criteria data entry interface is a wireless data link from a portable wireless communications device carried by the shopper to the shopping assistance device.

18. The system of claim 12, wherein said personal shopping criteria data entry interface is a wireless data link from a portable wireless communications device carried by the shopper to the shopping assistance device.

19. The system of claim 11, further comprising a display means for displaying information obtained by said tag reader to said user.

20. The system of claim 19, wherein said processor compares the information obtained by said tag reader to said personal shopping criteria and displays the result thereof to said user via said display means.

21. A method of assisting a shopper in selection of items meeting personally defined criteria by using an RFID scanner and reader device comprising steps of:
entering said shopper's defined shopping criteria into said RFID scanner and reader device;
automatically detecting and reading information from RFID tags on items in proximity to said RFID scanner and reader device;
comparing the characteristics of items whose tag information is read by said device to said shopper's defined shopping criteria; and
displaying product information associated with said items to said shopper.

22. The method of claim 21, wherein said step of automatically detecting and reading information from RFID tags on items further includes steps of communicating with a central processor having access to a product information database and retrieving product information from said database for display to said shopper.

23. The method of claim 22, wherein said displaying step is performed by wirelessly communicating said retrieved product information to a wireless communication device held by said shopper and displaying said product information thereon.

24. The method of claim 21, further comprising a step of alerting said shopper via said displayed information that said product information as to whether said product conforms to said shopper's personal selection criteria.

25. The method of claim 21, further comprising a step of alerting said shopper via displayed information that alternative products which are in conformance to said shopper's personal product selection criteria are available.

26. A computer program product embodied as computer executable program steps readable from a computer readable medium in association with a computer system associated with a shopper's assistance device, the computer program product comprising computer executable instructions for:
controlling entry of said shopper's personal product selection criteria into computer readable memory associated with said computer system;
controlling automatic detection of RFID tagged items in proximity to said shopper's assistance device;
controlling automatic reading of information from the RFID tags on said items; and
providing product information associated with said items to said shopper.

27. A computer program product as described in claim 26, further comprising computer executable instructions for:
retrieving product information from a product information database associated with said computer system;
comparing said product information with said shopper's personal product selection criteria entered into said computer readable memory; and
communicating the results of said comparison to said shopper.

28. A computer program product as described in claim 26, further comprising computer executable steps for displaying on a display means in association with said shopper's assistance device the results of said comparison.

29. A computer program product as described in claim 28, wherein said displaying step includes steps of displaying information to said shopper that alternative products in compliance with said shopper's personal product selection criteria are available.
